(19) United States
(12) Patent Application Publication
(10) Pub. No.: US 2005/0261150 A1
(43) Pub. Date: Nov. 24, 2005

(54) Reactive fluid systems for removing deposition materials and methods for using same

(75) Inventors: Clement R. Yonker, Kennewick, WA (US); John L. Fulton, Richland, WA (US); Daniel J. Gaspar, Richland, WA (US); Diane J. Hymes, San Jose, CA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, a part interest, Richland, WA (US)

(21) Appl. No.: 10/851,380

(22) Filed: May 21, 2004

(51) Int. Cl. C11D 1/00

(52) U.S. Cl. 510/175

(57) ABSTRACT

The present invention generally relates to methods for processing materials. More particularly, the present invention relates to reactive fluids and uses thereof for removing deposition materials, including, but not limited to, overburden materials, metals, non-metals, layered materials, organics, polymers, and semiconductor materials. The instant invention finds application in such commercial processes as semiconductor chip manufacturing.

### (1) FIELD OF THE INVENTION

The present invention generally relates to methods for processing materials. More particularly, the present invention relates to reactive fluids and uses thereof for removing deposition materials, including, but not limited to, overburden materials, metals, non-metals, layered materials, organics, polymers, and semiconductor materials. The instant invention finds application in such commercial processes as semiconductor chip manufacturing.

### (2) BACKGROUND

The semiconductor industry faces challenges to produce devices with increasingly smaller features and ever higher component density in order to enhance operating speeds and/or efficiency of the semiconductor chip. Semiconductor chips are composite structures typically comprising copper, tungsten, aluminum, and other metals, as well as silicon and various dielectric materials. Integrated circuits built on semiconductor surfaces are conventionally mult-layered patterned devices comprising silicon and other thinly layered and patterned materials or films. As more and more layers are deposited or built up on a semiconductor or wafer, flatness or non-planarity can become a problem. If not corrected, a faulty device can result. For example, preparation of the closely-spaced, finely-featured interconnect lines on a wafer requires the underlying dielectric material to be level. Fluids and methods that remove deposition materials in a selective and/or controlled manner or that provide for the leveling or planarizing of a surface while retaining critical features and patterns on a semiconductor chip can ultimately reduce industry processing costs.

Chemical Mechanical Planarization (CMP) is currently the method of choice in the art to level surfaces following deposition of copper overburdens that form the basis for semiconductor interconnects required for semiconductor chip fabrication. In conventional CMP, aqueous-based slurries containing abrasives such as aluminum oxide (Al₂O₃), silica (SiO₂), cerium oxide (CeO₂), or diamond particles abrade a surface with the aid of a pad actuated by mechanical action. Overburden material is removed and the wafer is planarized. However, problems with CMP processing are well known in the art. For example, preferential removal of material by action of bond pads in the middle of large features, called “dishing”, is well known in the art, a direct consequence of abrasive fluids used in conjunction with associated pressures imposed by mechanical polishing and pads used in CMP processing. Other dimensional changes to surface features, pattern structures, and vias are also routine. Accordingly, there remains a need for processing alternatives that do not require use of abrasives or mechanical polishing to remove deposition materials whereby dishing, rounding, and other critical dimension changes can be eliminated.

### SUMMARY OF THE INVENTION

The present invention generally relates to methods for processing materials. More particularly, the present invention relates to reactive fluids for removing deposition materials, including, but not limited to, overburden materials, metals, non-metals, layered materials, organics, polymers, and semiconductor materials. The reactive fluid systems of the present invention remove deposition materials without the need for aqueous-based and/or abrasive slurries currently used in semiconductor chip manufacturing thereby eliminating problems associated with CMP processing. Advantages of the present reactive fluid systems further include rapid, selective, and/or controlled removal of deposition materials. The present invention represents an advancement in deposition material processing, including, but not limited to, applications related to semiconductor chip manufacturing.

The reactive fluid of the present invention generally comprises: 1) a densified fluid wherein the fluid is a gas at standard temperature and pressure and wherein the density of the fluid is above the critical density of the fluid, 2) at least one reagent reactive toward at least one deposition material, including, but not limited to, overburden materials, metals, non-metals, layered materials, organics, polymers, and semiconductor materials whereby upon intermixing of the densified fluid and the at least one reactive reagent a reactive fluid is formed that selectively and controllably removes at least a portion of the deposition material. For example, a copper overburden material can be removed from a semiconductor or wafer by contacting the material with the reactive fluid.

The process of the present invention generally comprises 1) providing a densified fluid that is a gas at standard temperature and pressure wherein the density of the fluid is above the critical density of the fluid, 2) providing at least one reagent reactive toward at least one deposition material including, but not limited to, overburden materials, metals, non-metals, layered materials, organics, polymers, and semiconductor materials, 3) intermixing the densified fluid and the reactive reagent(s) wherein a reactive fluid is formed, and 4) contacting a deposition material with the reactive fluid whereby at least a portion of the deposition material is selectively and controllably removed. Additional, but optional steps include rinsing a material or surface with a pure densified or modified densified fluid to clean etch materials, solvents, organics, residues, or other spent reactive fluids containing deposition materials. Alternatively, reactive fluids of the present invention in combination with mechanical assists may be used to remove deposition materials. Choices for rinsing fluids include, but are not limited to, pure densified fluids, modified densified fluids, cleaning fluids, polar fluids and solvents, and combinations thereof. Choices for mechanical assists include, but are not limited to, pads such as polishing pads.

Reactions effecting removal of deposition materials in the reactive fluids include, but are not limited to, oxidation, reduction, exchange, association, dissociation, complexation, and combinations thereof. The reactive fluids remove deposition materials at rates preferably up to about 1000 nm/min. The wide range of rate choices means rates may be selected that best target a given deposition material of interest or a desired reaction condition. For example, rates may be selected for removing a specific deposition material at about 100 nm/min or another material at 500 nm/min.

It is an object of the present invention to provide a reactive fluid that optimizes removal of deposition materials.

It is further an object of the present invention to provide a reactive fluid that optimizes removal of overburden materials including metals such as copper.

It is still further an object of the present invention to provide a reactive fluid that removes imbedded materials including layered metals (e.g., a base copper layer) within a layered composite, e.g., a layered semiconductor.

### Glossary of Terms

The term “densified” as used herein comprises the group of compressed or liquefied gases and supercritical fluids having a fluid density (ρ) above the critical density (ρ_{c}) of the bulk fluid (i.e., ρ>ρ_{c}).

The term “reactive” in reference to the reactive fluid of the present invention defines chemical reagents and/or other constituents that react with and/or chemically modify deposition materials such that they are rapidly, selectively, and/or controllably removed.

The term “modifiers” defines any chemical reagent, constituent, or other additive introduced to the reactive fluids of the present invention to enhance solubility, cleaning, performance, speed, and/or efficiency of reactive reagents contained therein for removing or shaping of deposition materials.

The term “removing” in reference to the reactive fluids and processes of the present invention refers to any modification or processing whereby deposition materials are removed, moved, shaped, contoured, conformed, leveled, planarized, furrowed, ridged, coated, deposited, cleaned, and/or repaired.

### BRIEF DESCRIPTION OF THE DRAWINGS

A more complete appreciation of the invention will be readily obtained by reference to the following description of the accompanying drawings in which like numerals in different figures represent the same structures or elements.

FIG. 1 illustrates cross-sectional views of both a mixing chamber and a processing vessel for practicing the process of the present invention.

FIG. 2 illustrates a system for practicing the process of the present invention.

FIG. 3a presents a scanning electron micrograph (SEM) showing a view of a test wafer coupon in cross-section processed with a reactive fluid of the present invention.

FIG. 3b presents a SEM showing a view of a test wafer coupon in cross-section processed with a reactive fluid of the present invention.

FIG. 4 shows a SEM of a patterned wafer coupon processed with a reactive fluid containing a corrosion inhibitor showing partial and controlled removal of a copper metal layer according to a further embodiment of the present invention.

FIG. 5a presents a SEM of a semiconductor test coupon prior to treatment with a reactive fluid showing a copper overburden material deposited over a standard serpentine test pattern.

FIG. 5b presents a SEM of the semiconductor coupon in FIG. 5a following treatment with a reactive fluid according to a further embodiment of the present invention showing removal of the copper overburden material from both the feature channels and pattern feature surfaces.

FIG. 6a presents a SEM of a semiconductor test coupon selectively and controllably treated with a reactive fluid according to a further embodiment of the present invention. Feature arrays are exposed leaving copper overburden material untouched in the feature channels, evidence of the selectivity of the reactive fluid to a desired constituent.

FIG. 6b presents an enlarged SEM view of a section of the test coupon in FIG. 6a showing exposed feature arrays following treatment with a reactive fluid, evidence of the selectivity of the reactive fluid to a desired constituent.

FIG. 6c presents a SEM showing an Energy Dispersive X-Ray (EDX) analysis for copper of the test coupon of FIG. 6b, the bright mottled regions corresponding to copper remaining in the channels between the exposed array features and the dark regions corresponding to silicon in the exposed array features, evidence of the selectivity of the reactive fluid to a desired constituent.

FIG. 6d presents a SEM showing an EDX analysis for oxygen of the test coupon of FIG. 6b, the light speckled regions corresponding to oxygen present in the exposed feature arrays and the dark regions corresponding to copper remaining in the channels between the array features, evidence of the selectivity of the reactive fluid to a desired constituent.

FIG. 6e presents a SEM showing an EDX analysis for silicon on the test coupon in FIG. 6b, the light regions corresponding to silicon present in the exposed feature arrays and the dark regions corresponding to copper remaining in the channels between the feature arrays, evidence of the selectivity of the reactive fluid to a desired constituent.

FIG. 7a presents a scanning electron micrograph (SEM) of a section of a patterned test coupon overlaid with an overburden material following treatment with a reactive fluid of the present invention under generally static or symmetric-flow conditions.

FIG. 7b shows a SEM of a section of a patterned test coupon showing a portion of a trench array exposed following treatment with a reactive fluid under generally static or symmetric-flow conditions.

FIG. 7c shows a SEM of a section of a patterned test coupon showing a portion of a trench array exposed following treatment with a reactive fluid under generally active or asymmetric-flow conditions.

FIG. 7d shows a SEM of a section of a patterned test coupon showing a portion of a trench array exposed following treatment with a reactive fluid under generally active or asymmetric-flow conditions.

### DETAILED DESCRIPTION OF THE INVENTION

While the present invention is described herein with reference to the preferred embodiments thereof, it should be understood that the invention is not limited thereto, and various alternatives in form and detail may be made therein without departing from the spirit and scope of the invention. Those of ordinary skill in the art will appreciate that combining and intermixing the various fluids and reactive components as currently practiced and described herein may be effected in numerous and effectively equivalent ways. For example, application of the method steps on a commercial scale may comprise use of high-pressure pumps and pumping systems, transfer systems for moving, transporting, transferring, combining, intermixing, as well as delivering, spraying, and/or applying various reactive fluids. In addition, the associated application and/or processing techniques for using the reactive fluids of the present invention for conforming, contouring, shaping, leveling, planarizing, removing, cleaning, repairing, rendering, polishing, and layering surfaces, and combinations thereof, as well as post-processing collection of waste solutions and chemical constituents are also encompassed hereby.

The present invention embodies new approaches for processing of deposition materials, including overburden materials, metals, non-metals, layered materials, organics, polymers, and semiconductor materials. Processing as defined herein includes, but is not limited to, removing, shaping, leveling, contouring, planarizing, cleaning, rendering, and repairing. Reactive fluids of the present invention can be introduced as alternatives to etchants or abrasives currently employed in CMP process slurries in such commercial processes as semiconductor chip manufacturing. Because they do not employ abrasives, reactive fluids of the present invention can eliminate deleterious effects associated with CMP processing, including dishing, rounding, and critical dimension changes to features and pattern structures. Further, reactive fluids of the present invention remove deposition materials at rates comparable to those of conventional CMP processing. In addition, reactive fluids of the present invention exhibit coefficients of diffusion at least two orders of magnitude greater than comparable aqueous fluids employed in the art, and thus a greater range of reaction selectivity and control involving these fluids. Finally, fluids of the present invention exhibit substantially lower surface tension stresses on critical and intricate semiconductor features and patterns as compared to aqueous fluids known and used in the art, thus being ultimately useful for commercial semiconductor processing applications.

The densified fluids of the present invention comprise the group of compressed or liquefied gases and supercritical fluids having a fluid density (ρ) above the critical density (ρ_{c}) for the bulk fluid (i.e., ρ>ρ_{c}), including, but not limited to, carbon dioxide, ethane, ethylene, propane, butane, sulfurhexafluoride, and ammonia, including derivatives thereof, e.g., chlorotrifluoroethane. The critical density (ρ_{c}) is defined (“Properties of Gases and Liquids”, 3ed., McGraw-Hill, pg. 633) by the equation ρ_{c}=(1/V_{c})×(M.W.), where V_{c} is the critical volume (mL) and M.W. is the molecular weight (grams) of the constituent gas.

The densified fluids of the present invention preferably comprise carbon dioxide (CO₂) given the useful critical conditions (i.e., T_{c}=31° C., P_{c}=72.9 atm, CRC Handbook, 71^{st} ed., 1990, pg. 6-49), the critical density (ρ_{c}) being approximately 0.47 g/mL. Further, coefficients of diffusion in densified CO₂ are at least two orders of magnitude better than aqueous fluids employed in the art [see, e.g., Chemical Synthesis Using Supercritical Fluids, Philip G. Jessop, Waltner Leitner (eds.), Wiley—VCH, pg. 38], exhibiting at least a 100-fold greater range in diffusion and reaction selectivity and control relative to aqueous fluids. Additional advantages of the densified CO₂ include the ultimately lower surface tension exerted on intricate semiconductor features and patterns compared to aqueous-based fluids. For example, surface tension of water is about 73 dynes/cm at 20° C. (CRC Handbook, 71^{st} ed., 1990, pg. 6-8). In contrast, densified CO₂ exhibits a surface tension of 1.2 dynes/cm at 20° C. (“Encyclopedie Des Gaz”, Elsevier Scientific Publishing, 1976, pg. 338), a factor of about 60 below the surface tension for aqueous fluids.

Temperature of densified CO₂ is preferably in the range from about −80° C. to about 150° C. with a pressure up to about 10,000 psi. More preferably, a temperature may be selected up to about 60° C. with a pressure in the range from about 850 psi up to about 3000 psi. Most preferably, conditions are selected whereby temperature is at or near room temperature (about 20-25° C.), pressure is about 850 psi, and density in the densified liquid exceeds the critical density of pure CO₂ (i.e., ρ_{c} >0.47 g/cc). Appropriate workable temperature and pressure regimes above the critical density may be selected from a standard plot of reduced pressure (Pᵣ) as a function of reduced density (ρᵣ) whereby the corresponding reduced temperatures (Tᵣ) are specified. Reduced densities are preferably in the range from about 1 to 3 and more preferably in the range from about 1 to 2. The person of ordinary skill in the art will recognize that many selections for pressure and temperature are possible. In general, for densified fluids at super-critical fluid (SCF) conditions, the system need only exceed the critical parameters for CO₂. Thus, above a temperature of about 32° C., a pressure for a SCF system need only exceed the critical density of CO₂. Temperatures for SCF systems up to 150° C. are practicable if the density of the solution mixture is maintained above the critical density, meaning many density increases may be exploited in the densified fluid by effecting changes to pressure and/or temperature in the system. Similar or greater effects can be attained in SCF fluids where higher densities may be exploited as a function of pressure and/or temperature.

The reactive fluid of the present invention comprises reagents that when added to the densified fluid provide chemical reactivity, reactivity being defined by the ability of the reagents in the bulk densified fluid to chemically react with deposition materials, including overburden materials, thereby removing them, or selectively removing and re-depositing them, e.g., displacing them from a first position or location and re-depositing them in a second location.

Reactive chemical reagents are preferably soluble in the bulk densified fluid (e.g., CO₂), but are not limited thereto. For example, benzotriazole (BTA) as a chemical reagent is not directly soluble in pure densified CO₂; peroxide is only slightly soluble in pure densified CO₂. However, addition of a modifier such as a polar constituent ensures solubility and activity for reactive reagents like BTA and peroxide in the reactive fluid. Modifiers of the present invention are preferably selected from the group of CO₂-miscible organic solvents and polar liquids including, but not limited to, isopropyl alcohol, n-alkanols including, but not limited to, ethanol and methanol, and co-solvents such as water. Concentration of modifiers is preferably up to about 80 percent by volume or weight in the densified fluid. More preferably, concentration of modifiers is up to about 30 percent by volume or weight in the densified fluid. Most preferably, concentration of modifiers is less than or equal to about 30 percent by volume or weight in the densified fluid.

Substrates or surfaces treated with reactive fluids of the present invention may be optionally rinsed. For example, many deposition materials made soluble by reaction or oxidation of the material in contact with the reactive fluid are typically recovered by rinsing the material or substrate with a pure densified fluid. Materials not fully recovered using pure densified fluid may be recovered using more polar, modified fluids comprising modifiers including solvents such as isopropyl alcohol, e.g., a rinsing fluid comprising 15% by volume isopropyl alcohol in a bulk densified fluid. Other modifiers suitable as rinsing fluids include CO₂-philic agents, alcohols, acetones, ethers, phenols, and combinations thereof. Concentration of modifiers in a densified fluid used as a rinsing fluid is preferably up to about 80 percent by volume or weight. More preferably, concentration of modifiers is up to about 30 percent by volume or weight. Most preferably, concentration of modifiers is less than or equal to about 30 percent by volume or weight.

Reactive reagents may be selected from the group of mineral acids, fluorine-containing compounds and acids, organic acids, alkanolamines, peroxides and other oxygen-containing compounds, chelates, ammonia, and combinations thereof. Mineral acids are selected from the group of hydrochloric (HCl), sulfuric (H₂SO₄), phosphoric (H₃PO₄), and nitric (HNO₃), and their acid dissociation products or salts including H⁺, Cl⁻¹, HSO₄⁻¹, SO₄⁻², H₂PO₄⁻¹, HPO₄⁻², PO₄⁻³, etc. Preferred fluoride-containing compounds and acids include, but are not limited to, F₂, hydrofluoric acid (HF) and associated dilution acids thereof up to and including ultra-dilute hydrofluoric acid (e.g., 1:1000 dilution of 49 vol % HF in water). Preferred organic acids include the sulfonic acids (R—SO₃H) and corresponding salts, phosphate acids (R—O—PO₃H₂) and corresponding salts, and phosphate esters and salts, their derivatives, and functional equivalents. Preferred alkanolamines include, but are not limited to, ethanolamine (HOCH₂CH₂NH₂) and hydroxylamine (HO—NH₂), their derivatives and functional equivalents. Peroxides include, but are not limited to, organic peroxides (R—O—O—R′), t-butyl-alkyl-peroxides (H₃C)₃—C—O—O—R′), and hydrogen peroxide (H₂O₂). Oxygen containing compounds include, but are not limited to, O₂, ozone (O₃), alcohols (R—OH), phenols (Ar—OH), and esters (R—C—O—O—R′). Chelates include, but are not limited to, 1,1,1,5,5,5-hexa-fluoro-2,4-pentandione, e.g., hexa-fluoro-acetyl-acetonate or 2,4 pentanedione, 1,10-phenanthroline (C₁₂H₈N₂), aminopolycarboxylic acids including ethylene-di-amine-tetra-acetic-acid (EDTA), derivatives and salts (e.g., sodium EDTA), and oxalic acid [(COOH)₂]. The reactive reagents when intermixed with the bulk densified fluid raised to temperatures and pressures whereby the density (ρ) in the fluid exceeds the critical density (ρ_{c}) for the densified fluid effect formation of the reactive fluid. Effectiveness of the reactive constituents in the densified fluid toward overburden materials, including metals, is determined by the reactivity of, and reaction between the reagents and the targeted deposition materials or residues of interest. Other reagents may be added to impart useful properties to the reactive fluids. For example, corrosion inhibitors may be added to the reactive fluids imparting control over rates of reaction (e.g., oxidation) for removing deposition materials thereby providing reaction selectivity and/or controllability. Preferred corrosion inhibitors include, but are not limited to, benzotriazoles including benzotriazole (BTA) and 1,2,3-Benzotriazole, and catechols including catechol [2-(3,4-diethyleneamine], 1,2-di-hydroxy-benzene (pyrocatechol) and 2-(3,4-di-hydroxy-phenyl)-3,4-di-hydro-2H-1-benzopyran-3,5,7-triol (catechin), derivatives thereof, and combinations thereof. Other reactive chemical constituents and/or reagents may be added to the reactive fluids of the present invention to lend useful properties to the fluid. For example, reagents imparting time factor selectivity to the reactive fluids for removing, for example, a first metal layer or a subsequent material layer may be added. Concentration for reactive reagents in the reactive fluid or modified reactive fluid is preferably up to the limit of solubility for the reagent in the reactive fluid or modified reactive fluid. More preferably, concentration of reactive reagents is up to about 30 percent by volume or by weight in the reactive fluid, or modified reactive fluid. Most preferably, concentration of reactive reagents is less than or equal to about 5 percent by volume or by weight in the reactive fluid or modified reactive fluid.

Intermixing of the reactive reagents in the densified fluid forms the reactive fluid for removing deposition materials, including, but not limited to, overburden materials, semiconductor materials, metals, and non-metals. Effectiveness of a reactive fluid toward deposition materials is determined by the reactivity of, and reaction between, the reactive reagents in the fluid and the target materials of interest. In one of many likely reactions, for example, oxidation of an overburden material (e.g., a layered or deposited metal) by reaction with reactive constituents in a reactive fluid may result in dissolution of the material whereby the oxidized material detaches from and is removed from a surface. Alternatively, a reaction may involve a complexing reagent in the bulk densified fluid. Reactions involving the reactive reagents in the fluid include, but are not limited to, oxidation, reduction, exchange, association, dissociation, dissolution, complexation, binding, and combinations thereof.

A simplified mixing vessel, reaction vessel (chamber) and equipment of a benchtop scale design for practicing the process of the present invention will now be described. Those skilled in the art will recognize that numerous and equivalent constructs for practicing the invention are applicable. Thus, no limitation is intended by the present disclosure.

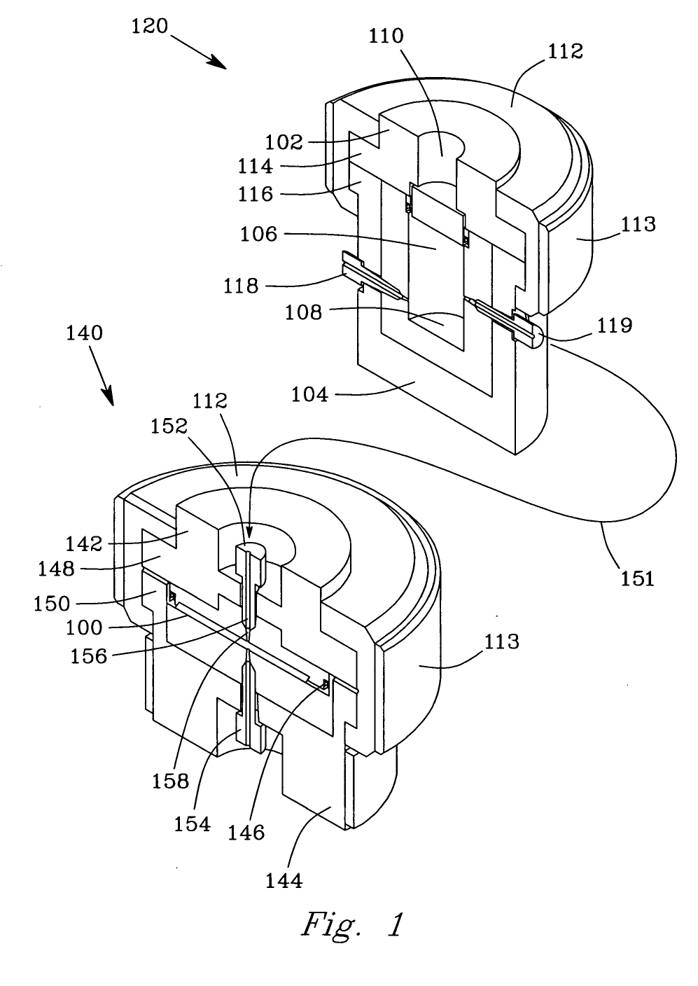

FIG. 1 illustrates both a mixing vessel 120 and a processing or reaction vessel 140 in cross section. The mixing vessel is comprised of a top vessel section 102 and a bottom vessel section 104 machined preferably of titanium metal. The mixing vessel may be lined with any of a number of high strength polymer liner(s) 106 to minimize potential of contaminating metals (e.g., Fe) being introduced into the processing vessel. The liner 106 is made of poly-ether-ether-ketone, also known as PEEK™ (Victrex USA Inc., Greenville S.C.) or an alternative such as poly-tetra-fluoro-ethylene (PTFE), also known as Teflon™ (Dupont Wilmington, Del.). When assembled, the top vessel section 102 and bottom vessel section 104 define a mixing chamber 108 having a length of 1.75 inches and an internal diameter of 1.14 inches and providing an internal volume of approximately 30 mL. Contents of the vessel are stirred with a magnetically coupled Teflon™ stir bar (not shown) via a standard temperature controlled heating plate (not shown). A sapphire observation window 110 (Crystal Systems Inc., Salem, Mass. 01970) is included in the top vessel section for observing fluids introduced into the vessel and for inspecting the phase behavior in the mixing solutions. The window has dimensions of about 1-inch in diameter and 0.5 inches in thickness. The vessel sections 102 and 104 and window 110 are assembled and secured in place with a clamp 112 that mounts to close over securing rim edge portions 114 and 116 machined into each of the top and bottom vessel sections, respectively, thereby effecting a pressure and temperature seal in the mixing vessel. The clamp is secured in place via a locking ring 113 positioned and aligned about the perimeter of the clamp 112.

Mixing vessel 120 is further configured with an inlet port 118 and an exit port 119. Flow of fluids into the mixing chamber is reversible as ports 118 and 119 may be used interchangeably as exit or inlet ports depending on desired flow direction. Ports 118 and 119 have dimensions in the range from 0.020 inches I.D. to 0.030 inches I.D.

The wafer processing vessel 140 is comprised of a top vessel section 142 and a bottom vessel section 144 machined preferably of titanium metal and lined with a high strength polymer liner (not shown). When assembled, the top section 142 and bottom section 144 define a processing chamber 146. Sections 142 and 144 are assembled and secured in place with a clamp 112 that mounts to close over securing rim portions 148 and 150 machined into each of the top and bottom vessel sections, respectively, effecting a pressure and temperature seal in the processing vessel. The clamp is secured in place via a screw-down locking ring 113 positioned and aligned about the perimeter of the clamp.

The processing vessel 140 is further configured with an inlet port 152 into the chamber 146 and an outlet port 154 from the chamber, each port having dimensions in the range from 0.020 inches I.D. to 0.030 inches I.D. The processing vessel has an internal diameter of 2.5 inches and a height of 0.050 inches defining a total chamber volume of approximately 500 μL. Processing fluids are introduced into the chamber through a small inlet hole 156 introduced in the top vessel portion 142 through the PEEK™ liner (not shown). The top vessel section 142 includes a 0.020 inch vertical channel head space above the wafer 100 surface whereby fluids introduced into the chamber 146 are dropped and accelerated to the wafer surface producing a radial flow field spread outward across the wafer surface e.g., radially outward.

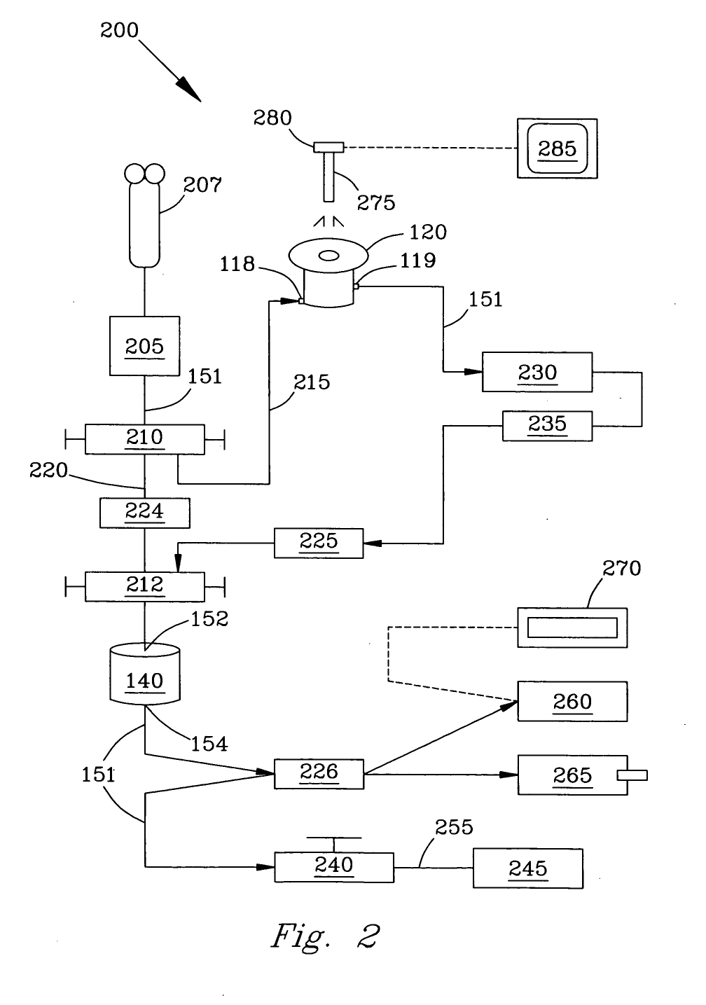

FIG. 2 illustrates a complete processing system 200 of a benchtop scale design for practicing the process of the present invention. The mixing vessel 120 is illustrated in fluid, pressure, and thermal communication with the processing vessel 140 via a series of high-pressure liquid chromatography transfer lines 151. Transfer lines 151 are made of PEEK™ (Upchurch Scientific Inc., Whidbey Island, Wash.) with dimensions 0.020 inch I.D. by 1/16-inch O.D. Pressure is maintained in the system using a feed pump 205 (for example, a 500 mL model #500-D microprocessor controlled syringe pump 205 from ISCO Inc., Lincoln, NB) in fluid connection with a tank 207 of ultra-high-purity CO₂. Valve 210 (for example, a model 15-15AF1 three-way/two-system combination valve from High Pressure Equipment Co., Erie, Pa.) is introduced into the transfer line 151 leading from pump 205 creating two independent flow paths 215 and 220.

Flow path 215 extends from valve 210 to the inlet port 118 of the mixing vessel 120 terminating at a second combination valve 212 (High Pressure Equipment Co., Erie, Pa.) allowing pure densified fluid to be introduced to the mixing vessel 120 and allowing for transfer of reactive fluids from the mixing vessel 120 to the processing vessel 140. A two-way T-fitting 225 (Upchurch Scientific, Inc., Whidbey Island, Wash.) inserted into path 215 between the exit port 119 of the mixing vessel 120 and valve 212 brings the mixing vessel 120 into fluid connection with the processing vessel 140. Further incorporated into path 215 between exit port 119 and T-fitting 225 are two inline filters, a 2 μm pre-filter 230 (Upchurch Scientific, Inc., Whidbey Island, Wash.) and a 0.5 μm post filter 235 (Upchurch Scientific, Inc., Whidbey Island, Wash.) that prevent potential contaminant metals in the reactive fluids from being introduced into processing vessel 140.

Flow path 220 extends from valve 210 to valve 212 and thereby to inlet port 152 of processing vessel 140. Incorporated into path 220 is a six-port sample valve 224 (for example, a model 7010 HPLC sample change valve, Rheodyne, Rohnert Park, Calif.) allowing for introduction of additional and various pure fluids directly into processing vessel 140, volumes being selectable in the range from about 1 μL to about 2.5 mL. Valves 210 and 212 in tandem permit isolation of flow path 215 from flow path 220 whereby fluids may be directed through either flow path.

A straight valve 240 (for example, a model 15-11AF1 two-way straight valve from High Pressure Equipment Co., Erie, Pa.) connects via standard 0.020-0.030 inch I.D. PEEK™ transfer line 151 to a three-way T-fitting 226 (Upchurch Scientific, Inc., Whidbey Island, Wash.) and to a waste collection vessel 245 via a “restrictor” segment 255 of PEEK™ transfer line having dimensions of approximately 0.005 inch I.D. by 6-inches in length. The T-fitting 226 is further connected via transfer line 151 to the exit port 154 of the processing vessel 140 and to an electronic pressure transducer 260 (for example, a model C451-10,000 transducer from Precise Sensors, Inc., Monrovia, Calif.) for reading and monitoring pressure in the system 200 and finally to a rupture disc 265 (for example, a model 15-61AF1 safety head from High Pressure Equipment Co., Erie, Pa.) used as a pressure safety vent.

In FIG. 2, the mixing vessel 120 is further shown being illuminated using a light source 275 (for example, a model 190 fiber optic illuminator 275 from Dolan-Jenner, St. Lawrence, Mass.). The light source preferably comprises a one foot long positional gooseneck fiber optic and a focusing lens equipped with a 30-watt bulb for focusing and directing light through the observation window 110 into the mixing chamber 108. A high performance camera 280 (for example, a Toshiba model IK-M41F2/M41R2 CCD camera from Imaging Products Group, Florence, S.C.) is also preferably coupled to and used in conjunction with the illuminator 275 and a standard terminal display 285 to image the mixing chamber and contents.

The reactive fluids are premixed in the mixing vessel 120 for approximately 5 to 10 minutes prior to transfer to the processing vessel 140. Pressure is programmed into and maintained by the microprocessor-controlled syringe pump 205. Metering of fluids from the mixing vessel 120 into the processing vessel 140 is initiated manually by opening the two-way straight valve 240 thereby initiating flow to and within the restrictor segment 255. Fluids are discharged at a rate of about 30 mL/min. Each transfer of fluid from the mixing vessel 120 involves about 7 mL of pre-mixed fluid. Closing of the valve 240 traps reactive fluid in processing vessel 140 whereby a deposition material on a surface in contact with the reactive fluid effects removal of the deposition material. Rinsing fluids are preferably introduced to the processing vessel 140 via processing loop 220. Rinsing fluids and other desired fluids or solvents may more preferably be introduced directly into the processing vessel 140 through processing loop 220. Rinsing fluids requiring premixing with other fluids or solvents may be introduced through the mixing vessel 120 to the processing vessel 140 via fluid loop 215. Post-processing examination of the test surfaces was conducted using conventional SEM and EDX analyses.

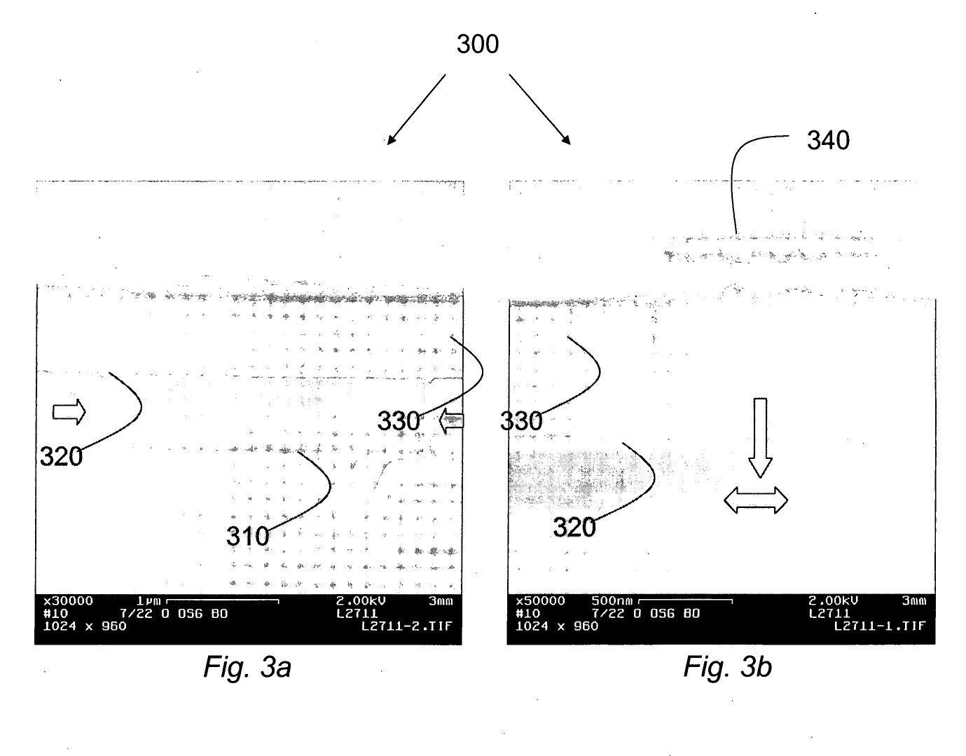

FIGS. 3a and 3b show a typical wafer coupon 300 tested in conjunction with the present invention. The coupon comprises an imbedded base layer 310 of a representative transition metal, e.g., elemental copper or other transition metal. The base layer is typically overlaid with an etch stop barrier layer 320 comprising silicon carbide (SiC) followed by an organosilane glass (OSG) material layer 330 or another low-k dielectric (LKD) material, and a cap coating or insulating overlayer 320 comprising silicon dioxide (SiO₂) or other thin film. In the test wafer coupon, small pattern wells or “vias” 340 were also present, being introduced through the OSG and the SiO₂ layers. The as-received test coupons were generally of a “barrier open” (BO) configuration, describing processing that breached the SiC etch stop layer. Test coupons were sized as necessary by scoring and breaking the wafers along the crystal planes.

A significant advantage of the reactive fluids of the present invention is post use recovery of waste constituents and regeneration of the reactive fluids. For example, waste constituents may be easily recovered from the bulk densified fluid by effecting rapid changes to temperature and/or pressure whereby capture of the recovered solvent in one stream and recovery of the modifiers and waste constituents in a separate stream allows for rapid and inexpensive recycling of the solvent. The person of ordinary skill in the art will quickly recognize the utility of the fluids of the present invention to many like applications. Thus, no limitation in scope is hereby intended by the disclosure of the preferred embodiments.

The following examples are intended to promote a further understanding of the reactive systems of the present invention. Example 1 details a reactive fluid that removes deposition materials completely from surfaces. Example 2 details a reactive fluid that removes deposition materials controllably from surfaces. Examples 3 and 4 details using a reactive fluid for selective targeting and removal of deposition materials. Example 5 details use of a reactive fluid for controlled removal of deposition materials using various flow fields and flow field geometries.

### EXAMPLE 1

In Example 1, a reactive fluid is described according to a first embodiment of the present invention for effecting essentially complete removal of deposition materials, including overburden materials and metals such as copper. The reactive fluid system comprises H₂O₂, isopropyl alcohol, and hexafluoroacetylacetonate (HFAc). An optional rinsing step with 60 mL of a modified fluid comprising 2 mL isopropyl alcohol in densified CO₂ was used. Peroxide (H₂O₂) as a reactive reagent is a moderate oxidizer that removes deposition materials by oxidation or by altering the chemical state of the material. For example, elemental copper (Cu°) in the presence of peroxide undergoes oxidation to an ionic state (e.g., Cu¹⁺ or Cu²⁺). The reactive fluid further comprises hexafluoroacetylacetonate (HFAc) which complexes with any free oxidized metal. The fluid of the instant embodiment has very attractive attributes for commercial processing including very low quantities of modifiers, very low volatility, ease of fluid recovery, low toxicity, and elimination or minimization of critical feature and dimension changes.

Experimental. The 30 mL mixing vessel 120 was charged with 1.5 mL (˜5% by volume) isopropyl alcohol (Aldrich Chemical Co., Milwaukee, Wis. 53201), 300 μL of 70 mM HFAc (Aldrich Chemical Co., Milwaukee, Wis. 53201), 100 μL of H₂O₂ (Aldrich Chemical Co., Milwaukee, Wis. 53201) prepared to a solution strength of 30 volume percent by dissolution in H₂O. Constituents were added to the bottom section 104 of the mixing vessel 120. The bottom vessel was subsequently capped with the top vessel 102 forming the mixing chamber 108. The sapphire window 110 was inserted into the upper vessel portion and the vessel clamp 112 and clamping ring 113 were secured in place on the mixing vessel thereby effecting a temperature and pressure seal in the vessel. The vessel was then charged with densified CO₂ via the inlet port 116 and the multiphase fluid was allowed to intermix for about 5 to 10 minutes. The processing vessel 140 was also pre-loaded with a test coupon having dimensions in the range from 1 to 1.75 inches on a side. The processing vessel was charged with pure densified CO₂ 130 via the inlet port 152. Transfer of the reactive processing fluid into the mixing vessel was effected via manual opening of a two-way valve 530 in pressure and temperature connection with the processing vessel. Temperature in the processing vessel was maintained at about 22° C. with a pressure of 3000 psi to maintain density of the mixture above the critical density for CO₂, about 0.47 g/cc. The test coupon had a contact time in the reactive fluid of about 5 minutes, but is not limited thereto. Contact times with or in the reactive fluid up to about 150 minutes are preferred.

Following wafer processing to remove overburden material, the test coupon was optionally rinsed using a rinsing fluid comprising 2 mL isopropyl alcohol in 60 mL of pure densified CO₂, introduced to the processing vessel 140 to remove the reactive fluid and to quench any further reactions.

Results. FIGS. 3a and 3b show SEM micrographs of an OSG “barrier open” (BO) test wafer coupon 300 treated with the reactive fluid. Given the absence of a via 340 opening in FIG. 3a, a segment of the imbedded base copper layer 310 was not contacted by the fluid and thus was not removed. In FIG. 3b, removal of the imbedded or base copper layer was essentially complete given its exposure to and contact with the reactive fluid introduced through the via 340 opening. Analysis results using X-Ray Photo-Electron Spectroscopy (XPS) showed the level of copper remaining in the coupon following reaction with the reactive fluid was about 7.2×10⁺¹² atoms/cm², comparable to a key industry measure for contamination level cleaning, the monolayer residue standard (about 2×10¹² atoms/cm²). Based on the 15,000 Å (1500 nm) layer thickness, rate for removing imbedded copper was from about 40 nm/min to about 100 nm/min under flow-processing conditions.

Results demonstrate that deposition materials contacted by reactive fluids of the present invention can be removed. Altering of surfaces, substrates, composites, layers, and/or deposition materials may be required to contact a desired deposition material with a reactive fluid. Altering includes, but is not limited to, actions selected from boring, drilling, cutting, breaking, shearing, puncturing, exposing, etching, mechanically rendering, and combinations thereof.

### EXAMPLE 2

In Example 2, a reactive fluid is described according to a further embodiment of the present invention useful for removing deposition materials selectively and controllably, including metals such as copper. The reactive fluid system comprised H₂O₂, isopropyl alcohol, and hexafluoroacetylacetonate (HFAc), as prepared in Example 1, to which a corrosion inhibitor, benzotriazole (BTA), was added. A rinsing step with 90 mL of a fluid comprising 2 mL isopropyl alcohol in CO₂ was optionally used.

Experimental. The reactive fluid of the present embodiment was prepared by charging the mixing vessel 120 with 1.5 mL (˜5% by volume) isopropyl alcohol (Aldrich Chemical Co., Milwaukee, Wis.), 300 μL of 70 mM HFAc (Aldrich Chemical Co., Milwaukee, Wis.), 100 μL of a 30% H₂O₂ (Aldrich Chemical Co., Milwaukee, Wis.) solution by volume, and 50 mg (14 mM) BTA (Aldrich Chemical Co., Milwaukee, Wis. 53201). Solid constituents were added to the bottom vessel section 104 of the mixing vessel 120; liquid constituents (e.g., HFAc, H₂O) were subsequently added. Contents were premixed for a period of from 5-10 minutes by charging the vessel 120 with pure densified CO₂ at a temperature of about 20° C. and pressure of about 3000 psi. The 500 μL processing vessel 140 was also pre-loaded with an OSG “barrier open” (BO) test coupon 400 as described in Example 1. The processing vessel 140 was charged with pure densified CO₂ 130 via the inlet port 152 at a temperature of about 22° C. and a pressure of 3000 psi. Transfer of the reactive processing fluid into the mixing vessel 120 was effected via manual opening of a two-way valve 130 in pressure and temperature connection with the processing vessel 140. Temperature in the processing vessel 140 was maintained at about 22° C. with a pressure of 3000 psi to maintain density of the mixture above the critical density for CO₂, about 0.47 g/cc. The wafer coupon had a contact time in the reactive fluid of about 5 minutes but was not limited thereto. Contact times with or in the reactive fluid up to about 150 minutes are preferred.

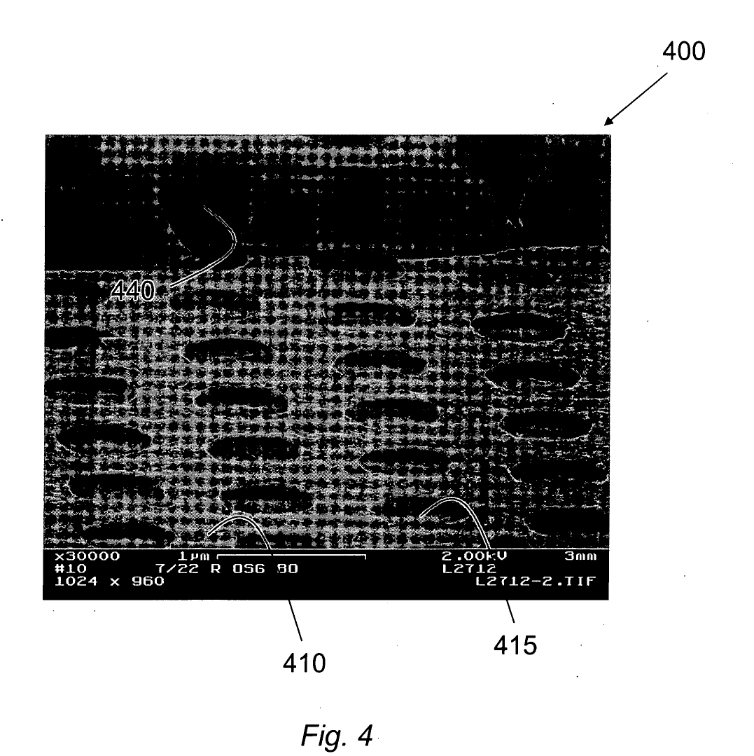

Results. FIG. 4 shows an SEM micrograph for the test coupon 400 treated with the reactive fluid of the instant embodiment. Contact time with the reactive fluid was identical in Examples 1 and 2. In the figure a series of well patterns 415 are shown etched into the base copper layer 410 below the pattern vias 440 by action of the reactive fluid. However, complete removal of copper from the base layer 410 was not observed despite full contact with the reactive fluid. The slower reaction rate in Example 2 for removal of copper compared to Example 1 was attributed to the addition of BTA. BTA competes with HFAc in the reactive fluid for reaction sites with copper thereby slowing the reaction rate, leading to retention of a portion of copper in the layer 410.

Results show that removal of deposition materials, including metal from an imbedded metal layer, can be selectively and controllably performed using reactive fluids comprising appropriate reagents. Other chemical constituents may likewise be added to the reactive fluids of the present invention based on their useful and/or anticipated chemical properties without deviating from the scope of the invention. For example, the addition of a corrosion inhibitor decreases the rate of the oxidation reaction slowing removal of copper by the complexant HFAc from the base layer 410. The instant fluid system effectively removes metals and may find application in commercial processing, for example, in the semiconductor chip industry. All such applications as would be used by the person of ordinary skill in the art are incorporated herein.

### EXAMPLE 3

In yet another embodiment of the present invention, an approach for removing overburden materials selective to a specific metal, layer, or material has been demonstrated using the reactive fluid, prepared as in Example 1.

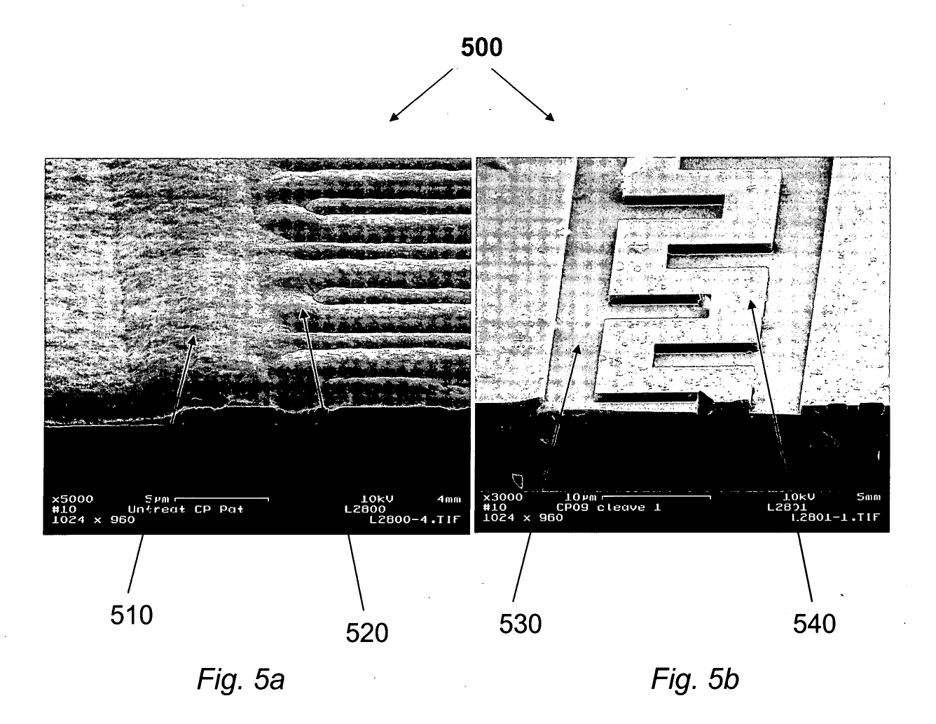

Experimental. A test coupon 500 (931AZ copper CMP Characterization Test Chip, MIT/Sematech, Austin, Tex.) comprising a 16,000 Å copper overburden (i.e., 15,000 ÅCu ECP+1000 Å Cu seed layer), and a 250 Å TaN barrier was treated by contacting with the reactive fluid prepared in Example 1 at a temperature of 22° C. and a pressure of 3000 psig. The test coupon had a contact time in the reactive fluid of about 140 minutes but was not limited thereto. Contact times with or in the reactive fluid up to about 150 minutes are preferred. FIG. 5a presents an SEM micrograph of the test coupon 500 with copper overburden 510 before treatment with the reactive fluid, showing the overburden material covering the patterned features 520 on the wafer 500.

Results. FIG. 5b shows an SEM micrograph of the coupon 500 following treatment with the reactive fluid. As shown in the figure, the copper overburden material was selectively and rapidly removed using the reactive fluid, leaving the serpentine-shaped TaN feature 540 untouched. Further, no degradation, rounding, or dimension changes to the feature edges were observed. In the instant example, removal of overburden materials, including metals such as copper (e.g., Cu), has been demonstrated in a fashion that is selective to a first material leaving an underlying structure or feature untouched. In addition, selective control of the reaction has been demonstrated that achieves a desired reaction outcome, i.e., removal of a overburden material while preventing deleterious dishing, rounding, and/or other critical dimension changes to layers 530 and patterned features 540.

In general, removal of deposition materials, including, but not limited to, overburden materials, metals, non-metals, composite layers, semiconductor materials including dielectric and OSG materials, and other materials or constituents can be effected by selecting reagents reactive toward a first material, but not reactive, or less reactive, toward a second material. Further, combinations of reagents may be selected whereby a first reagent in the reactive fluid reacts with a first constituent and a second or subsequent reagent reacts with a second or subsequent constituent or material, respectively. Reagent combinations as would be selected by the person of ordinary skill in the art are incorporated.

### EXAMPLE 4

In Example 4, yet another embodiment for removing deposition materials selective to a specific metal, layer, or material has been demonstrated using the reactive fluid prepared as in Example 1. In the instant embodiment, selective removal of a deposition material from a semiconductor substrate comprising featured arrays and/or surface patterns of silicate material (SiO₂) has been demonstrated.

Experimental. A test coupon 600 (e.g., a 931AZ copper CMP Characterization Test Chip, MIT/Sematech, Austin, Tex.) comprising arrays of feature patterns 610 of TEOS oxide (Sematech, Austin, Tex.) overlaid with a copper overburden material was tested in conjunction with the reactive fluid of the present invention. Typical depth of the overburden material in the coupons 600 was 16,000 Å A (over a 250 Å Ta barrier). Reaction selectivity and control relative to removal of deposition materials was tested using Energy Dispersive X-Ray (EDX) analysis. Qualitative and quantitative data provided by EDX provided for measurement of concentrations and/or depths for remaining material(s). For a given rate of reaction and time of residence in the processing vessel 140, estimates of the desired reaction times were subsequently calculated, allowing for reaction termination at any layer depth or degree desired. In the instant example, reaction was terminated at a depth that exposed the feature arrays. SEM analysis was used to view surfaces following removal of deposition material per unit time.

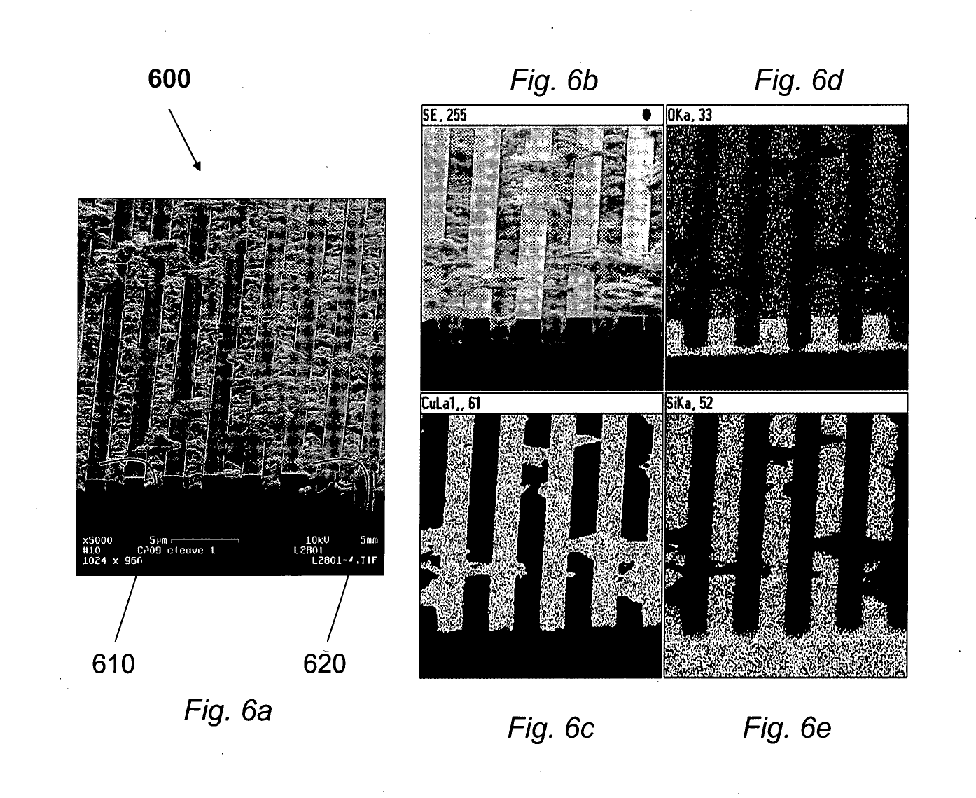

Results. FIG. 6a presents a SEM of the semiconductor test coupon 600 treated with the reactive fluid. Results show the patterns or feature arrays 610 are exposed leaving some copper overburden material untouched in the channels 620 between the features, evidence of selectivity of the reactive fluid to a desired constituent and control over the extent or degree of removal. FIG. 6b presents an enlarged SEM view of a section of the test coupon in FIG. 6a showing feature arrays exposed following treatment with the reactive fluid. Results show remaining copper is largely centered in the channels between the feature arrays, confirming the selective removal of the copper overburden and control over the extent of removal. FIG. 6c presents a SEM showing an Energy Dispersive X-Ray (EDX) analysis for copper of the test coupon of FIG. 6b, bright mottled regions corresponding to copper remaining in the channels between the exposed array features and dark regions corresponding to silicon in the exposed array features, evidence of the selectivity of the reactive fluid to remove a desired constituent, i.e., the copper overburden material. FIG. 6d presents a SEM showing an EDX analysis for oxygen of the test coupon of FIG. 6b, light speckled regions corresponding to oxygen present in the exposed feature arrays and dark regions corresponding to an absence of oxygen (and thus copper remaining) in the channels between the exposed feature arrays. Again, selectivity of the reactive fluid to the copper overburden material is demonstrated. FIG. 6e presents a SEM showing an EDX analysis for silicon on the test coupon in FIG. 6b, light regions corresponding to silicon present in the exposed feature arrays and dark regions corresponding to absence of silicon (and thus copper remaining) in the channels between the feature arrays, evidence of the selectivity of the reactive fluid to a desired constituent. EDX analysis results confirm the ability of the reactive fluid to selectively remove specific overburden materials and to controllably remove them to a desired depth, level, and/or degree. For example, deposition material can be selectively removed to a specific depth or degree, e.g., as would be required to expose surface features or pattern arrays below a deposition or overburden material in commercial processing, e.g., semiconductor processing or other industry surface processing. The person of ordinary skill will recognize that various analysis techniques in combination with diffusion- and/or flow-control of the reactive fluids of the present invention would allow fine tuning of rates for removing deposition materials. Thus, no limitation is intended by the specific example disclosed.

In an alternate aspect of the present embodiment, materials targeted for removal may be selected that are more reactive or less reactive to the reactive fluid than are counterpart materials for a different or subsequent material layer. Alternatively, selective removal may proceed or be accomplished by changing fluid composition wherein a first reactive reagent targets one deposition material, overburden material, metal, non-metal, layer, or other constituent, leaving the second material untouched or unreacted. Comparable techniques as would be selected by the person of ordinary skill in the art are hereby incorporated.

### EXAMPLE 5

In yet another embodiment of the present invention, selective removal of deposition materials specific to a given metal, layer, or material has been demonstrated using various flow-fields or field-geometries in conjunction with the reactive fluid prepared as in Example 1.

Experimental. A test coupon 700 (931AZ copper CMP Characterization Test Chip, MIT/Sematech, Austin, Tex.) comprising feature arrays or patterns 710 was tested in conjunction with the reactive fluid. Typical depth of the overburden material in the coupons was 16,000 Å (over a 250 Å Ta barrier). In the processing vessel 140, reactive fluid was introduced above the test coupon into the reaction chamber 146 and dripped incrementally onto the coupon positioned centrally below the inlet 152. Flow of reactive fluid in the processing vessel occurred essentially from right to left across the coupon from the point of contact. In places, flow was essentially static or symmetric. In other locations, flow was observed to be generally active and/or asymmetric. Thus, effects of various flow-fields and flow-field geometries on sections of the test coupon were investigated following contact with the reactive fluid.

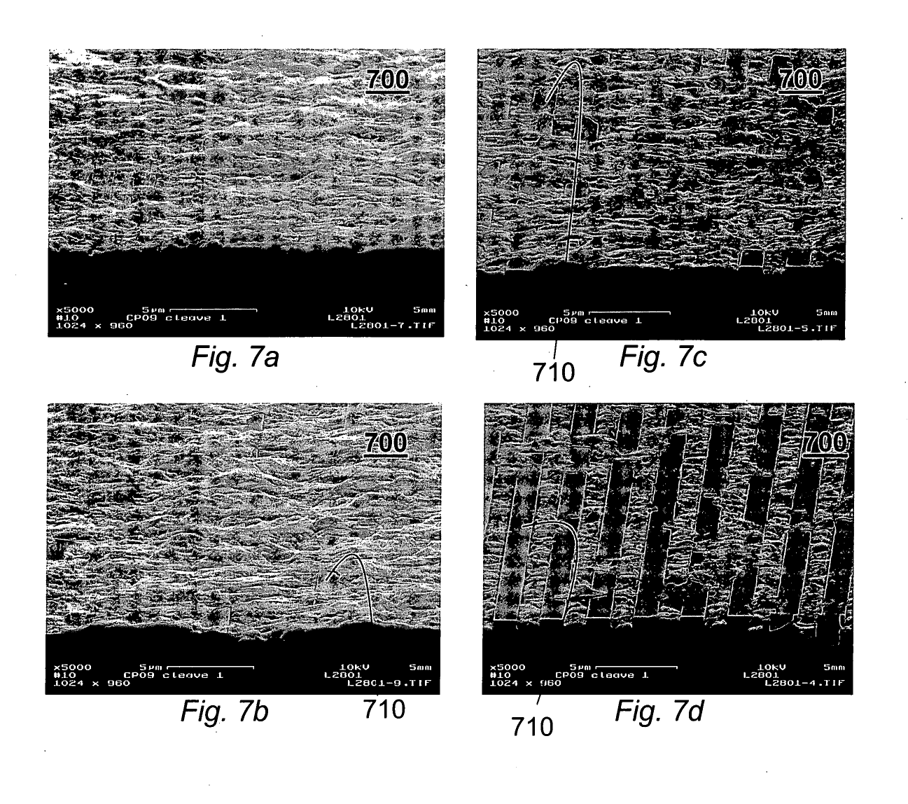

Results. Because flow across the coupon was not constant or uniform in the vessel, different flow patterns were observed over the coupon. Generally, reactive fluid flowed diagonally left across the coupon and toward the coupon edge. Because reactive fluid was introduced from the top of the chamber near the center of the test coupon, contact with the coupon resulted in combinations of both radial and/or symmetric flows, as well as turbulent and/or asymmetric flows. Asymmetric and/or turbulent flows were observed near the left-most edges of the coupon. Symmetric and/or radial flows were observed more centrally across the face of the coupon. In general, flow was observed from right to left across the coupon, resulting in a sloped removal pattern across the test coupon, with the least overburden material remaining at the far left of the coupon and the most overburden material remaining at the far right of the coupon. FIGS. 7a-7d present scanning electron micrographs (SEM) for four different sections of the semiconductor coupon 700 contacted by the reactive fluid of the instant embodiment. FIG. 7a presents a SEM of a first section of a patterned test coupon treated under generally static or symmetric-flow conditions with the reactive fluid. Results show removal of the overburden material was generally uniform with selective control over the degree of removal to a depth just above the feature arrays or patterns. FIG. 7b shows a SEM of a second section of a patterned test coupon sectioned near the right of the coupon following treatment with a reactive fluid again under generally static or symmetric-flow conditions. Results show the feature array or pattern 710 beginning to be exposed by action of the reactive fluid. FIG. 7c shows a SEM of a third section of a patterned test coupon sectioned near the left of the coupon wherein contact with the reactive fluid was under generally active and/or asymmetric-flow conditions. Results show a greater exposure of the feature array elements following treatment and thus a greater degree of removal of the overburden material. FIG. 7d shows a SEM of a fourth section of a patterned test coupon near the left of the coupon wherein contact with the reactive fluid was under generally active and/or asymmetric-flow conditions. Results show the greatest exposure of the feature array elements following treatment and thus the greatest degree of removal of the overburden material. Results are attributed to the dynamics of the asymmetric and/or turbulent flow at the far left edge of the test coupon where reactive fluid was observed leaving the coupon. Results in FIG. 7a and FIG. 7b are indicative of slower diffusion-controlled reaction conditions with the reactive fluid where the reactive fluid remained fairly unperturbed and static. Results in FIG. 7c and FIG. 7d, in contrast, were indicative of the more active removal pattern for overburden materials under more dynamic flow conditions. In general, flow-controlled removal of deposition materials may comprise flows selected from radial, tangential, turbulent, laminar, asymmetric, symmetric, gradient, dynamic, channeled, and combinations thereof.

In one aspect of the instant embodiment, reactive fluids may be sprayed, directed, delivered, or applied to a material using various mechanical actuators and mechanical delivery systems whereby specific pattern flows with the reactive fluid are generated on the material contacted by the reactive fluid whereby selective removal of the desired deposition material occurs. Alternatively, selective removal of deposition materials may be effected by contacting a material with a reactive fluid, followed by selective spin rotation of the substrate or material whereby radial distribution of the fluid occurs thereby removing, contouring, shaping, or leveling (e.g., planarizing) a material. Optional rinsing or additional processing of the contoured material or surface with a alternate fluid of different composition completes the processing.

In yet another aspect of the present embodiment, reactive fluid may be directed to contact a deposition material in a narrow focal point, including, for example, processing of a semiconductor material whereby spot shaping or spot contouring of the material is effected by selective spraying of a reactive fluid followed by rapid temperature and/or pressure changes to effect recovery of constituents in the reactive fluid.

In yet another aspect, selective removal of deposition materials may be effected by spinning or rotating the material or surface comprising the deposition material whereby a reactive fluid contacts the material in various and/or alternate ways. For example, flow fields including, but not limited to, radial flow, tangential flow, turbulent flow, asymmetric flow, symmetric flow, gradient flow, channeled flow, and combinations thereof may be generated. Alternatively, a deposition material may be processed by such actions as dipping or immersing the material in a reactive fluid, allowing for top-down flows across a material or surface or a portion thereof thereby removing or otherwise shaping the deposition material.

In general, results have demonstrated that deposition materials can be selectively and/or controllably removed using various flow fields and/or surface geometries with the reactive fluid. Thus, no limitations in flow choices are intended by the preferred embodiments and disclosed aspects in Example 5. In general, all flow fields and/or geometries as would be used by a person of ordinary skill in the art are hereby incorporated.

In yet another embodiment, reactive fluids of the present invention may be used in combination with mechanical assists, such as commercial processing pads, for applications including, but not limited to, buffing, polishing, shaping, contouring, leveling, planarizing. Because the reactive fluids of the present invention do not use abrasives or abrasive components, pads ranging in degree of hardness from soft to rigid may be used as mechanical assists for removing deposition materials. Thus, deposition materials, including, but not limited to, overburden materials, metals, non-metals, and other constituents may be selectively removed from a substrate or surface while the surface or substrate is simultaneously protected from mechanical intrusion and/or damage typically caused by standard abrasive components in a processing fluid. In one aspect of the instant embodiment, for example, a reactive fluid may be used in a first processing step to selectively and controllably remove an overburden material contacted by a reactive fluid whereby removal of the material may proceed to a first processing point, including, but not limited to a first removal depth, followed by a second finishing step whereby a mechanical assist, e.g., polishing pad, may be used to finalize the processing. For example, a metal overburden material not removed in a first processing step may be removed in a second polishing or buffing step. Advantages include selective control over the quantity or depth of removed overburden material, and a lower time of mechanical contact with a finishing pad thereby minimizing processing damage. Selectivity for a given deposition material may be defined using many standard chemical reactivity measures known in the art including, but not limited to, redox potentials, solubility products, free energy, reaction enthalpy, entropy, or combinations thereof.

In yet another aspect of the present embodiment, a plurality of reactive fluids each selective to a specific deposition material, constituent, metal, non-metal, or overburden material may be employed, whereby the targeted deposition materials are selectively removed in a step-wise, tiered, or top-down, fashion from the host composite or layered material. For example, in a manufacturing process involving a semiconductor chip having both a silicon oxide layer and a copper interconnect layer, a reactive fluid may be used to remove the silicon oxide material layer leaving the copper interconnect layer intact. Alternately, the copper interconnect layer may be removed using a reactive fluid leaving the silicon layer intact. Further, step-wise and/or selective removal may be done in combination with, or in the absence of, mechanical polishing/processing assists such as a commercial polishing pad.

In yet another aspect of the instant embodiment, mechanical actuators may be used to generate various pattern flows for a reactive fluid in contact with a deposition material whereby removal of the deposition materials may be effected in a particular or specific manner. For example, actuators rotating at variable speeds, at various angles and positions, and in various directions (e.g., circular rotation) above the plane of a deposition material can create specific pattern flows or flow-field geometries that effect removal of deposition material. The person of ordinary skill in the art will recognize that numerous other combinations, aspects, and equivalents of the present embodiment may be used, with or without mechanical assists. All such combinations are hereby incorporated.

In yet another embodiment, a semiconductor material damaged during processing may be repaired by selective removal or dissolution of a first deposition material from a first location with subsequent and selective deposition of the removed material to a second location proximate to, or remote from, the first location whereby deposition of the first material may be used to fill or level a depression, hole, divot, or other disparity thereby repairing the defect. For example, selective repair of a defect in a semiconductor chip may be made by application of a first reactive fluid at a first location whereby a first deposition material (e.g., overburden or metal) is removed followed by subsequent deposition of the material in a second location thereby effecting repair. Changes to the reactive fluid including, but not limited to, temperature, pressure, composition, addition of new constituents, and/or subsequent combination with other fluids imparts control of both reactivity and/or deposition of the desired material. Alternatively, dissolution in a reactive fluid of a first material (e.g., copper metal) required for repair may be made with delivery of the reactive fluid to a second location wherein a defect exists whereby changes to the reactive fluid may result in selective deposition of the material contained within the reactive fluid. For example, drop-wise delivery of a reactive fluid containing a dissolved metal or other constituent into a defect, divot, hole, depression, or other disparity may result in selective deposition of the dissolution material within the defect site by effecting simple changes (e.g., temperature, pressure, constituent addition) to the fluid thereby effecting repair. Fluids of the instant embodiment may be tailored to remove or to shape deposition materials including, but not limited to, overburden materials, metals, non-metals, semiconductor materials and constituents including, but not limited to, cap layer materials such as SiC, stop barrier layers including SiO₂ and TaN, metal layers including Cu and Al, feature layer materials including OSG and other low-k dielectric materials, and combinations thereof.

In yet another aspect of the present embodiment, a specific site or spot correction is practicable. For example, in a semiconductor chip comprising pattern vias wherein seed deposition layers comprising metals for interconnects are deposited, localized repair may be warranted when a seed layer is unevenly, irregularly, or improperly deposited ultimately leading to a faulty device. Further, selective removal of unevenly, irregularly, or improperly deposited material may be made with a reactive fluid from a pattern, feature, or material layer thereby correcting the pattern, feature, or material layer.

In another aspect, repairing may comprise selective removal of various deposition materials in succession using reactive fluids of differing composition followed by deposition of any of the number of removed materials in at least one location having an incorrect quantity of material thereby repairing the deposition material layer. Alternatively, selective deposition may effect construction or build-up of layered overburden materials.

In yet another embodiment of the present invention, reactive fluids may be used to clean or process various surfaces, including, but not limited to, manufacturing or processing surfaces, deposition surfaces, processing pad surfaces, substrate surfaces, and semiconductor surfaces, and combinations thereof, wherein unwanted process residues reside. Residues include, but are not limited to, etch residues, plasma residues, vapor deposition residues, sputtered deposition residues, and combinations thereof. For example, surfaces such as deposition chamber surfaces, semiconductor deposition chamber surfaces, cleaning chamber surfaces, and combinations thereof may require cleaning to remove residues such as etch residues or materials, plasma residues or materials, vapor deposition materials, and/or other sputtered materials accumulated during processing. In one aspect of the present embodiment, a combined processing and cleaning chamber may be constructed wherein metals or other materials in a manufacturing process are first deposited, followed by cleaning of the chamber by action of a reactive fluid to remove unwanted deposition residues. For example, in semiconductor processing, use of a combined deposition and cleaning chamber may be employed wherein the chamber is used for the manufacture or processing followed by cleaning of the chamber with a reactive fluid thereby eliminating the need for additional and separate costly processing chambers. For example, in one aspect, an auto-cleaning process chamber for post semiconductor barrier deposition processing and cleaning of surfaces thereof is practicable. All equivalents as would be applied by the person of ordinary skill in the art are hereby incorporated.

In still another embodiment, surface processing may occur whereby metal or overburden materials may be selectively removed from one side, or one section, of a first surface but not another. For example, in semiconductor package processing, a metal or overburden material layer deposited or processed on one side or location of a wafer or semiconductor chip may be reactively or chemically removed while an opposing or adjacent surface is protected from the chemical removing process by standard masking techniques. In an alternate aspect of the present embodiment, a first surface material may be processed (e.g., shaped, contoured) using the reactive fluids of the present invention followed by masking, inactivation, or protection of the first processed surface with subsequent later processing of the same surface or of an alternate surface.

In yet another embodiment of the present invention, metals overburden, and other materials may be selectively removed using a combination of reactive fluids in succession or by adding further reagents or constituents to a reactive fluid. For example, a first metal or first overburden material may be removed from a first or top layer of a composite material using a first reactive fluid, followed by removal of a second metal or material, situated below the first, using a second reactive fluid or by addition of a second constituent to the reactive fluid that is reactive or selective to the second material or constituent, followed by removal of a third material, metal, or overburden layer below the second using a third reactive fluid or by addition of a third reactive constituent to the reactive fluid whereby selective step-wise processing and/or top-down removal of materials in a composite may be effected. In the instant embodiment, mechanical assists including, but not limited to, polishing or buffing pads may be used to contour, shape, or otherwise finalize a material or surface. In yet another aspect, reactive fluids may be applied in conjunction with use of various mechanical actuation or processing machinery and/or assists.

In yet another embodiment of the present invention, reactive fluids of the present invention may be used to clean surfaces of processing pads for re-use in commercial applications, including those associated with conventional CMP processing. For example, replacement pads are indicated when pad surfaces become clogged or plugged with abrasives or overburden materials actively removed during mechanical processing. Once clogged or sufficiently ineffective, pads are discarded and not reused. Given the expense of such pads and the demonstrated ability of the reactive fluids of the present invention to remove overburden and deposition materials, reactive fluids may be used to clean and recondition CMP pads and other processing pads for reuse, thereby decreasing processing costs. For example, pads comprising multiple and/or various residues may be reconditioned for reuse.

In yet another embodiment, reactive fluids of the present invention may comprise additional reagents, modifiers, or constituents whereby a time selectivity factor or time constant is introduced for removing deposition materials from surfaces, including metals and/or overburden materials. For example, grain-boundary adsorbers may be added as reactive reagents to the bulk reactive fluids thereby introducing time selective control over reaction rates governing removal of deposition materials.

While the preferred embodiments of the present invention have been shown and described, it will be apparent to those skilled in the art that many changes and modifications may be made without departing from the invention in its true scope and broader aspects. The appended claims are therefore intended to cover all such changes and modifications as fall within the spirit and scope of the invention.

1. A reactive fluid for removing deposition material, comprising:
a densified fluid and at least one reactive reagent.

2. The reactive fluid of claim 1, wherein said densified fluid comprises at least one member selected from carbon dioxide, ethane, ethylene, propane, butane, sulfurhexafluoride, ammonia, modifiers, or combinations thereof.

3. The reactive fluid of claim 2, wherein said modifiers are selected from CO₂-miscible organic solvents, CO₂-miscible polar liquids, isopropyl alcohol, n-alkanols, ethanol, methanol, water, and combinations thereof.

4. The reactive fluid of claim 3, wherein said modifiers comprise a concentration of up to about 80 percent by volume in said densified fluid.

5. The reactive fluid of claim 1, wherein said reagent is selected from mineral acids, fluorine-containing compounds and acids, organic acids, alkanolamines, peroxides, oxygen-containing compounds, chelates, corrosion inhibitors, ammonia, and combinations thereof.

6. The reactive fluid of claim 5, wherein said corrosion inhibitors are selected from benzotriazoles, benzotriazole, 1,2,3-benzotriazole, catechols, catechol, pyrocatechol, catechin, and combinations thereof.

7. The reactive fluid of claim 6, wherein said corrosion inhibitors comprise a concentration of up to about 5% by volume.

8. The reactive fluid of claim 5, wherein said chelates are selected from hexafluoroacetylacetonate, EDTA, sodium EDTA, 1,10 phenanthroline, oxalic acid, and combinations thereof.

9. The reactive fluid of claim 5, wherein said peroxides are selected from organic peroxides, t-butyl alkyl peroxides, hydrogen peroxide, and combinations thereof.

10. The reactive fluid of claim 5, wherein said reactive reagents comprise a concentration of up to about 30% by volume.

11. The reactive fluid of claim 5, wherein said reactive reagent comprises a concentration of up to about 5% by volume.

12. A reactive fluid for removing deposition material, comprising:
a densified fluid and at least one reagent reactive toward at least one deposition material.

13. The reactive fluid of claim 12, wherein said densified fluid comprises at least one member selected from carbon dioxide, ethane, ethylene, propane, butane, sulfurhexafluoride, ammonia, modifiers, or combinations thereof.

14. The reactive fluid of claim 13, wherein said modifiers are selected from CO₂-miscible organic solvents, CO₂-miscible polar liquids, isopropyl alcohol, n-alkanols, ethanol, methanol, water, and combinations thereof.

15. The reactive fluid of claim 14, wherein said modifiers comprise a concentration of up to about 80 percent by volume in said densified fluid.

16. The reactive fluid of claim 12, wherein said deposition material is selected from overburden materials, non-metals, semiconductor materials, low-k dielectrics, organosilane glasses, polymers, organics, metals, metal nitrides, metal oxides, silicon oxides, silicon carbide, and combinations thereof.

17. The reactive fluid of claim 16, wherein said metals are Cu, Al, or combinations thereof.

18. The reactive fluid of claim 12, wherein said reagent is selected from mineral acids, fluorine-containing compounds and acids, organic acids, alkanolamines, peroxides, oxygen-containing compounds, chelates, corrosion inhibitors, ammonia, and combinations thereof.

19. The reactive fluid of claim 18, wherein said corrosion inhibitors are selected from benzotriazoles, benzotriazole, 1,2,3-benzotriazole, catechols, catechol, pyrocatechol, catechin, and combinations thereof.

20. The reactive fluid of claim 19, wherein said corrosion inhibitors comprise a concentration of up to about 5% by volume.

21. The reactive fluid of claim 18, wherein said chelates are selected from hexafluoroacetylacetonate, EDTA, 1,10 phenanthroline, oxalic acid, and combinations thereof.

22. The reactive fluid of claim 18, wherein said peroxides are selected from organic peroxides, t-butyl alkyl peroxides, hydrogen peroxide, and combinations thereof.

23. The reactive fluid of claim 18, wherein said reagent comprises a concentration of up to about 30% by volume.

24. The reactive fluid of claim 18, wherein said reagent comprises a concentration of up to about 5% by volume.

25. The reactive fluid of claim 12, wherein said reagent introduces time-selective control for removing deposition materials.

26. The reactive fluid of claim 25, wherein said reagent is a grain-boundary adsorber.

27. A process for removing deposition material, comprising:
contacting a deposition material with a reactive fluid thereby removing at least a portion of said material.

28. The reactive fluid of claim 27, wherein said reactive fluid comprises at least one member selected from carbon dioxide, ethane, ethylene, propane, butane, sulfurhexafluoride, ammonia, modifiers, or combinations thereof.

29. The reactive fluid of claim 28, wherein said modifiers are selected from CO₂-miscible organic solvents, CO₂-miscible polar liquids, isopropyl alcohol, n-alkanols, ethanol, methanol, water, and combinations thereof.

30. The reactive fluid of claim 29, wherein said modifiers comprise a concentration of up to about 80 percent by volume in said reactive fluid.

31. The process of claim 27, wherein said deposition material is selected from overburden materials, metals, non-metals, semi-conductor materials, low-k dielectrics, organo-silane glasses, polymers, organics, metal nitrides, metal oxides, silicon oxides, silicon carbide, and combinations thereof.

32. The process of claim 27, wherein said reactive fluid comprises at least one reagent selected from mineral acids, fluorine-containing compounds and acids, organic acids, alkanolamines, chelates, corrosion inhibitors, peroxides, oxygen-containing compounds, grain-boundary adsorbers, ammonia, and combinations thereof.

33. The process of claim 32, wherein said chelates are selected from hexafluoroacetylacetonate, EDTA, sodium-EDTA, 1,10 phenanthroline, oxalic acid, and combinations thereof.

34. The process of claim 32, wherein said corrosion inhibitors are selected from benzotriazoles; benzotriazole; 1,2,3-benzotriazole; catechols; catechol; pyrocatechol, catechin, and combinations thereof.

35. The process of claim 34, wherein said corrosion inhibitors comprise a concentration of up to about 5% by volume.

36. The process of claim 32, wherein said peroxides are selected from organic peroxides, t-butyl alkyl peroxides, hydrogen peroxide, and combinations thereof.

37. The process of claim 32, wherein said reagent comprises a concentration of up to about 30% by volume.

38. The process of claim 32, wherein said at least one reactive reagent comprises a concentration of up to about 5% by volume.

39. The process of claim 27, wherein removing said deposition material comprises chemical reactions selected from oxidation, reduction, exchange, association, dissociation, dissolution, complexation, binding, and combinations thereof.

40. The process of claim 27, wherein removing said deposition material is essentially complete.

41. The process of claim 27, wherein removing said deposition material is partial, selective, controlled, and combinations thereof.

42. A process for removing deposition material, the steps comprising:
providing a densified fluid;
intermixing said densified fluid and at least one reagent reactive toward at least one deposition material thereby forming a reactive fluid; and
contacting said deposition material with said reactive fluid thereby removing at least a portion of said material.

43. The reactive fluid of claim 42, wherein said densified fluid comprises at least one member selected from carbon dioxide, ethane, ethylene, propane, butane, sulfurhexafluoride, ammonia, modifiers, or combinations thereof.

44. The reactive fluid of claim 43, wherein said modifiers are selected from CO₂-miscible organic solvents, CO₂-miscible polar liquids, isopropyl alcohol, n-alkanols, ethanol, methanol, water, and combinations thereof.

45. The reactive fluid of claim 44, wherein said modifiers comprise a concentration of up to about 80 percent by volume.

46. The process of claim 42, wherein said deposition material is selected from overburden materials, metals, non-metals, semi-conductor materials, low-k dielectrics, organo-silane glasses, polymers, organics, metal nitrides, metal oxides, silicon oxides, silicon carbide, and combinations thereof.

47. The process of claim 42, wherein said at least one reagent is selected from mineral acids, fluorine-containing compounds and acids, organic acids, alkanolamines, chelates, corrosion inhibitors, peroxides, oxygen-containing compounds, grain-boundary adsorbers, ammonia, and combinations thereof.

48. The process of claim 47, wherein said chelates are selected from hexafluoroacetylacetonate, EDTA, 1,10 phenanthroline, oxalic acid, and combinations thereof.

49. The process of claim 47, wherein said corrosion inhibitors are selected from benzotriazoles; benzotriazole; 1,2,3-benzotriazole; catechols; catechol; pyrocatechol, catechin, and combinations thereof.

50. The process of claim 49, wherein said corrosion inhibitors comprise a concentration of up to about 5% by volume.

51. The process of claim 47, wherein said peroxides are selected from organic peroxides, t-butyl alkyl peroxides, hydrogen peroxide, and combinations thereof.

52. The process of claim 47, wherein said at least one reactive reagent comprises a concentration of up to about 30% by volume.

53. The process of claim 47, wherein said at least one reactive reagent comprises a concentration of up to about 5% by volume.

54. The process of claim 42, wherein removing comprises a chemical reaction selected from oxidation, reduction, exchange, association, dissociation, dissolution, complexation, binding, and combinations thereof.

55. The process of claim 42, wherein removing comprises use of a mechanical assist to enhance removal of said deposition material.

56. The process of claim 55, wherein said mechanical assist is selected from pads, actuators, or combinations thereof.

57. The process of claim 42, wherein removing said deposition material is essentially complete.

58. The process of claim 42, wherein removing said deposition material is partial, selective, controlled, and combinations thereof.

59. The process of claim 58, wherein selective removing comprises spinning and rotating a surface in contact with said reactive fluid.

60. The process of claim 58, wherein selective removing comprises effecting selective or top-down flow of said reactive fluid across said deposition material or a portion thereof by dipping or immersing in said reactive fluid.

61. The process of claim 58, wherein controlled removing is selected from rate-controlled, diffusion-controlled, flow-controlled, flow-field-controlled, geometrically-controlled, or combinations thereof.

62. The process of claim 61, wherein flow-controlled removing comprises a flow field selected from radial, tangential, turbulent, laminar, asymmetric, symmetric, gradient, dynamic, channeled, and combinations thereof.

63. The process of claim 62, wherein flow-controlled removing further comprises mechanical rotation or spin actuation of a surface thereby removing said material.

64. The process of claim 42, wherein contacting comprises dripping said reactive fluid on said deposition material.

65. The process of claim 42, wherein contacting comprises directing said reactive fluid to a focal point on said deposition material.

66. The process of claim 42, wherein contacting effects a change to said material selected from shaping, contouring, repairing, and combinations thereof.

67. The process of claim 66, wherein repairing comprises selective removal of a first material from a first location and selective deposition of said material at a second location thereby repairing a member selected from defects, depressions, holes, divots, disparities, irregularities, or combinations thereof.

68. The process of claim 66, wherein repairing comprises dissolution of at least one deposition material in contact with said reactive fluid whereby changes to pressure, temperature, or composition of said reactive fluid results in deposition of said material in at least one second location thereby repairing a member selected from defects, depressions, holes, divots, disparities, irregularities, or combinations thereof.

69. The process of claim 66, wherein repairing comprises delivering said reactive fluid containing said material to a defect location thereby repairing said defect.

70. The process of claim 66, wherein repairing comprises selective removal of at least one deposition material or a portion thereof followed by deposition of said material in at least one different location.

71. The process of claim 42, wherein contacting comprises selectively removing said material to at least one depth with said reactive fluid, with a mechanical assist, or combinations thereof.

72. The process of claim 42, wherein contacting selectively removes a first deposition material leaving a second deposition material intact.

73. The process of claim 42, wherein contacting selectively removes said material step-wise or top-down.

74. The process of claim 42, wherein removing comprises removing said material from a layer selected from seed, pattern, feature, or combinations thereof thereby correcting said layer.

75. The process of claim 42, wherein removing comprises removing a residue from a surface.

76. The process of claim 75, wherein said residue is selected from etch residues, plasma residues, vapor deposition residues, sputtered deposition residues, and combinations thereof.

77. The process of claim 75, wherein said surface is selected from manufacturing surfaces, processing surfaces, deposition surfaces, deposition chamber surfaces, cleaning chamber surfaces pad surfaces, substrate surfaces, semiconductor surfaces, semiconductor deposition chamber surfaces, and combinations thereof.

78. The process of claim 77, wherein said deposition chamber surface is a post semiconductor barrier deposition chamber surface.

79. The process of claim 42, wherein removing is from a first surface but not a second surface.

80. The process of claim 42, wherein removing is from a first non-masked surface adjacent to a second masked surface.

81. The process of claim 42, wherein removing comprises removing a first material using a first reactive fluid and removing a second material using a second reactive fluid in succession thereby effecting step-wise processing of a composite or layered deposition surface.

82. The process of claim 42, wherein removing comprises removing at least one deposition material from a processing pad thereby reconditioning said pad for reuse.

83. The process of claim 42, wherein said reactive fluid is applied in conjunction with use of mechanical actuation equipment or assists.

84. The process of claim 42, wherein contacting comprises a time of up to about 150 minutes.

85. The process of claim 42, wherein removing comprises removing said deposition material from a semiconductor.

86. The process of claim 42, wherein removing comprises a member selected from shaping, contouring, leveling, planarizing, cleaning, repairing, polishing, rendering, and combinations thereof.

87. The process of claim 42, wherein removing comprises selective removal of said material from a first location with subsequent deposition in a second location.

88. The process of claim 42, wherein removing occurs at rates up to about 1000 nm/min.

89. The process of claim 42, wherein removing occurs at rates up to about 100 nm/min.

90. A process for shaping a deposition material, the steps comprising:
providing a densified fluid;
intermixing said densified fluid and at least one reagent reactive toward at least one deposition material; and
contacting said deposition material with said reactive fluid thereby shaping said material.

91. The reactive fluid of claim 90, wherein said densified fluid comprises at least one member selected from carbon dioxide, ethane, ethylene, propane, butane, sulfurhexafluoride, ammonia, modifiers, or combinations thereof.

92. The reactive fluid of claim 91, wherein said modifiers are selected from CO₂-miscible organic solvents, CO₂-miscible polar liquids, isopropyl alcohol, n-alkanols, ethanol, methanol, water, and combinations thereof.

93. The reactive fluid of claim 92, wherein said modifiers comprise a concentration of up to about 80 percent by volume in said densified fluid.

94. The process of claim 90, wherein said deposition material is selected from overburden materials, semiconductor materials, metals, non-metals, organics, polymers, and combinations thereof.

95. The process of claim 90, wherein said reagent is selected from mineral acids, fluorine-containing compounds, hydrofluoric acid and dilution acids thereof, organic acids, alkanolamines, peroxides, oxygen-containing compounds, chelates, corrosion inhibitors, phosphate acids, ammonia, and combinations thereof.

96. The process of claim 95, wherein said at least one reactive reagent comprises a concentration of up to about 30% by volume.

97. The process of claim 95, wherein said reagent comprises a concentration of up to about 5% by volume.

98. The process of claim 95, wherein chelates are selected from hexafluoroacetylacetonate, EDTA, sodium EDTA, 1,10 phenanthroline, oxalic acid, or combinations thereof.

99. The process of claim 95, wherein peroxides are selected from organic peroxides, t-butyl alkyl peroxides, hydrogen peroxide, and combinations thereof.

100. The process of claim 95, wherein said corrosion inhibitors comprise a concentration of up to about 5% by volume.

101. The process of claim 90, wherein contacting comprises a member selected from spraying, dipping, immersing, coating, flowing, wicking, and combinations thereof.

102. The process of claim 90, wherein shaping comprises a member selected from removing, contouring, planarizing, leveling, depositing, repairing, rendering, masking, and combinations thereof.

103. The process of claim 102, wherein shaping further comprises rotating or spin-actuating of a surface.

104. The process of claim 102, wherein shaping further comprises using a mechanical pad in a non-abrasive chemical mechanical polishing or processing of said material.

105. The process of claim 90, wherein shaping comprises removing said material to a first depth with said reactive fluid in conjunction with use of a non-abrasive mechanical polishing or processing of said material to planarize said material.

106. The process of claim 105, wherein shaping further comprises rotating an actuating member above the plane of said material thereby generating a flow field for removing said material in contact with said reactive fluid.

107. The process of claim 106, wherein said flow field is selected from radial, tangential, turbulent, asymmetric, symmetric, gradient, channeled, and combinations thereof.

108. The process of claim 90, wherein shaping is used in a semiconductor chip manufacturing process.

109. The process of claim 90, wherein contacting comprises a time of up to about 150 minutes.

110. A process for removing imbedded material, comprising the steps:
providing a densified fluid;
intermixing said densified fluid and at least one reagent reactive toward at least one imbedded material; and
contacting said imbedded material with said reactive fluid thereby removing at least a portion of said material.

111. The reactive fluid of claim 110, wherein said densified fluid comprises at least one member selected from carbon dioxide, ethane, ethylene, propane, butane, sulfurhexafluoride, ammonia, modifiers, or combinations thereof.

112. The reactive fluid of claim 111, wherein said modifiers are selected from CO₂-miscible organic solvents, CO₂-miscible polar liquids, isopropyl alcohol, n-alkanols, ethanol, methanol, water, and combinations thereof.

113. The reactive fluid of claim 112, wherein said modifiers comprise a concentration of up to about 80 percent by volume in said densified fluid.

114. The process of claim 110, wherein said reagent is selected from mineral acids, fluorine-containing compounds, hydrofluoric acid and dilution acids thereof, organic acids, alkanolamines, peroxides, oxygen-containing compounds, chelates, corrosion inhibitors, phosphate acids, ammonia, and combinations thereof.

115. The process of claim 114, wherein said reagent comprises a concentration of up to about 30% by volume.

116. The process of claim 114, wherein said reagent comprises a concentration of up to about 5% by volume.

117. The process of claim 110, wherein said imbedded material is selected from non-metals, semi-conductor materials, low-k dielectrics, organo-silane glasses, polymers, organics, metals, metal nitrides, metal oxides, silicon oxides, silicon carbide, and combinations thereof.

118. The process of claim 110, wherein removing said material is essentially complete.

119. The process of claim 110, wherein removing said material is partial, selective, controlled, and combinations thereof.

120. The process of claim 119, wherein controlled removing is selected from rate-controlled, diffusion-controlled, flow-controlled, flow-field-controlled, geometrically-controlled, or combinations thereof.

121. The process of claim 110, wherein contacting comprises altering a surface whereby said reactive fluid can contact said material.

122. The process of claim 121, wherein altering is selected from boring, drilling, cutting, breaking, shearing, puncturing, exposing, etching, mechanically rendering, and combinations thereof.

123. The process of claim 110, wherein contacting comprises a time of up to about 150 minutes.

124. A process for removing deposition material, the steps comprising:
contacting at least one deposition material with a reactive fluid comprising a densified fluid and at least one reagent reactive toward a deposition material thereby removing at least a portion of said material.

125. The reactive fluid of claim 124, wherein said densified fluid comprises at least one member selected from carbon dioxide, ethane, ethylene, propane, butane, sulfurhexafluoride, ammonia, modifiers, or combinations thereof.

126. The reactive fluid of claim 125, wherein said modifiers are selected from CO₂-miscible organic solvents, CO₂-miscible polar liquids, isopropyl alcohol, n-alkanols, ethanol, methanol, water, and combinations thereof.

127. The reactive fluid of claim 126, wherein said modifiers comprise a concentration of up to about 80 percent by volume in said densified fluid.

128. The process of claim 124, wherein said deposition material is selected from overburden materials, metals, non-metals, semi-conductor materials, low-k dielectrics, organo-silane glasses, polymers, organics, metal nitrides, metal oxides, silicon oxides, silicon carbide, and combinations thereof.

129. The process of claim 124, wherein said at least one reagent is selected from mineral acids, fluorine-containing compounds and acids, organic acids, alkanolamines, chelates, corrosion inhibitors, peroxides, oxygen-containing compounds, grain-boundary adsorbers, ammonia, and combinations thereof.

130. The process of claim 129, wherein said at least one reagent comprises a concentration of up to about 30% by volume.

131. The process of claim 129, wherein said at least one reagent comprises a concentration of up to about 5% by volume.

132. The process of claim 129, wherein said chelates are selected from hexafluoroacetylacetonate, EDTA, sodium EDTA, 1,10 phenanthroline, oxalic acid, and combinations thereof.

133. The process of claim 129, wherein said corrosion inhibitors are selected from benzotriazoles; benzotriazole; 1,2,3-benzotriazole; catechols; catechol; pyrocatechol, catechin, and combinations thereof.

134. The process of claim 133, wherein said corrosion inhibitors comprise a concentration of up to about 5% by volume.

135. The process of claim 129, wherein said peroxides are selected from organic peroxides, t-butyl alkyl peroxides, hydrogen peroxide, and combinations thereof.

136. The process of claim 124, wherein removing comprises chemical reactions selected from oxidation, reduction, exchange, association, dissociation, dissolution, complexation, binding, and combinations thereof.

137. The process of claim 124, wherein removing said deposition material is essentially complete.

138. The process of claim 124, wherein removing said deposition material is partial, selective, controlled, and combinations thereof.

139. The process of claim 138, wherein selective removing comprises spinning and rotating a material in contact with said reactive fluid.

140. The process of claim 138, wherein selective removing comprises effecting selective or top-down flow of said reactive fluid across the deposition material or a portion thereof by dipping or immersing in said reactive fluid.

140. The process of claim 138, wherein controlled removing is selected from rate-controlled, diffusion-controlled, flow-controlled, flow-field-controlled, geometrically-controlled, or combinations thereof.

141. The process of claim 140, wherein flow-controlled or flow-field-controlled removing comprises flow fields selected from radial, tangential, turbulent, laminar, asymmetric, symmetric, gradient, dynamic, channeled, and combinations thereof.

142. The process of claim 140, wherein said flow-controlled or flow-field-controlled removing further comprises mechanical rotation or spin actuation of a surface thereby effecting removal of said material.

143. The process of claim 140, wherein said flow-controlled removing comprises dripping said reactive fluid on said material.

144. The process of claim 124, wherein contacting comprises directing said reactive fluid to a focal point on said deposition material.

145. The process of claim 124, wherein contacting with said reactive fluid effects a change to said material selected from shaping, contouring, repairing, and combinations thereof.
